(19) United States
(12) Patent Application Publication
(10) Pub. No.: US 2008/0319792 A1
(43) Pub. Date: Dec. 25, 2008

(54) INVOICING METHOD AND APPARATUS FOR THERAPEUTIC TREATMENTS

(76) Inventor: Christopher Bulley, Etobicoke (CA)

Correspondence Address: HEENAN BLAIKIE LLP, P. O. BOX 185, SUITE 2600, 200 BAY STREET, SOUTH TOWER, ROYAL BANK PLAZA, TORONTO, ON, M5J 2J4, CA

(21) Appl. No.: 12/144,300

(22) Filed: Jun. 23, 2008

Related U.S. Application Data
(60) Provisional application No. 60/945,718, filed on Jun. 22, 2007.

(51) Int. Cl. G06Q 20/00

(52) U.S. Cl. 705/2

(57) ABSTRACT

A method of providing compensation for therapeutic treatments involves establishing a therapeutic services membership having an associated compensation plan. The compensation plan establishes a maximum monetary payment amount for therapeutic treatments. Therapeutic treatments are rendered to a recipient of the therapeutic services membership. The rendered therapeutic treatments have an associated monetary value. Compensation is subsequently effected to the recipient in accordance with the compensation plan. The compensation provides the therapeutic treatments to the recipient without monetary payment when the total monetary value of the rendered therapeutic treatments exceeds the maximum monetary payment amount.

### RELATED APPLICATIONS

This patent application claims the benefit of the filing date of U.S. patent application Ser. No. 60/945,718, filed Jun. 22, 2007, entitled “Therapeutic Treatments Membership”, the contents of which are incorporated herein by reference.

### FIELD

This disclosure relates to a method of subsidizing the costs of therapeutic treatments.

### BACKGROUND

Unless subsidized through group or personal health insurance, the costs of therapeutic treatments can create a barrier to the individual in need of such treatments. Unfortunately, many health insurance programs do not compensate the individual for the entire cost of these treatments, either by limiting the maximum payable each year or by limiting the costs of each treatment. Other health insurance programs provide no compensation for certain therapeutic treatments. As a result, individuals may choose to forego prescribed therapeutic treatments, thereby exacerbating the ailment and increasing subsequent health care costs.

### SUMMARY

A method and apparatus are provided that subsidize the costs of therapeutic treatments through a therapeutic treatment membership.

In one aspect of this disclosure, there is provided a method of providing compensation for therapeutic treatments that involves establishing a therapeutic treatment membership having an associated compensation plan. The compensation plan establishes a maximum monetary payment amount for therapeutic treatments. Therapeutic treatments are then rendered to a recipient of the therapeutic treatment membership. The rendered therapeutic treatments have an associated monetary value. Compensation is subsequently effected to the recipient in accordance with the compensation plan. The compensation may provide the therapeutic treatments to the recipient without monetary payment when the total monetary value of the rendered therapeutic treatments exceeds the maximum monetary payment amount.

The step of effecting compensation may comprise providing to the recipient proof of performance of the rendered therapeutic treatments in accordance with the associated monetary value, such that the monetary value of the proof of performance does not exceeding the maximum monetary payment amount. The proof of performance may comprise a tax receipt or a receipt for receiving reimbursement from an insurance plan.

In another aspect of this disclosure, there is provided a method of providing compensation for therapeutic treatments that involves establishing a therapeutic treatment membership having an associated compensation plan and a treatment schedule. The compensation plan establishes a maximum monetary payment amount for therapeutic treatments, and a monetary value for each one of the therapeutic treatments. The treatment schedule establishes a maximum authorized total number of the therapeutic treatments and/or a maximum authorized frequency of performance of the therapeutic treatments.

An indication of one of the therapeutic treatment memberships is then received. The indication of the one therapeutic treatment membership may be received at an input device to a computer, or may provided to an admissions clerk at a therapeutic services facility. One of the therapeutic treatments is then rendered to a recipient of the one therapeutic treatment membership in accordance with the treatment schedule. A receipt is issued to the recipient for the monetary value of the rendered therapeutic treatment only if the total monetary value of the therapeutic treatments rendered to the recipient is less than the maximum monetary payment amount.

On the other hand, no receipt is issued to the recipient if the total monetary value of the therapeutic treatments rendered to the recipient is not less than the maximum monetary payment amount. Alternately, the recipient may upgrade to a different therapeutic treatment membership, or may pay for additional therapeutic treatments, and receive a receipt for the additional therapeutic treatments.

In another aspect of this disclosure, there is provided a therapeutic treatment compensator that comprises a therapeutic treatment membership database, and a compensation processor that is configured for communication with the database. The therapeutic treatment membership database defines at least one therapeutic treatment membership. Each therapeutic treatment membership has an associated compensation plan definition and treatment schedule definition. The compensation plan definition comprises a maximum monetary payment amount for therapeutic treatments, and a monetary value for each one of the therapeutic treatments. The treatment schedule definition comprises a maximum authorized total number of the therapeutic treatments and/or a maximum authorized frequency of performance of the therapeutic treatments.

The compensation processor is configured to authorize the rendering of one of the therapeutic treatments to a recipient of the therapeutic treatment membership in accordance with the treatment schedule definition, and to issue a receipt to the recipient for the monetary value of the rendered therapeutic treatment only if a total of the monetary values of the rendered therapeutic treatments is less than the maximum monetary payment amount.

The compensation processor does not issue a receipt if the total monetary value of the therapeutic treatments rendered to the recipient is not less than the maximum monetary payment amount. Alternately, the recipient may upgrade to a different therapeutic treatment membership, or may pay for additional therapeutic treatments, and receive a receipt for the additional therapeutic treatments.

### BRIEF DESCRIPTION OF THE DRAWINGS

The invention will now be described, by way of example only, with reference to the accompanying drawings, in which:

FIG. 1 is a schematic view of a therapeutic treatment compensator that is configured to provide compensation for therapeutic treatments; and

FIGS. 2a and 2b together comprise a flow chart that depicts a method of providing compensation for therapeutic treatments.

### DETAILED DESCRIPTION

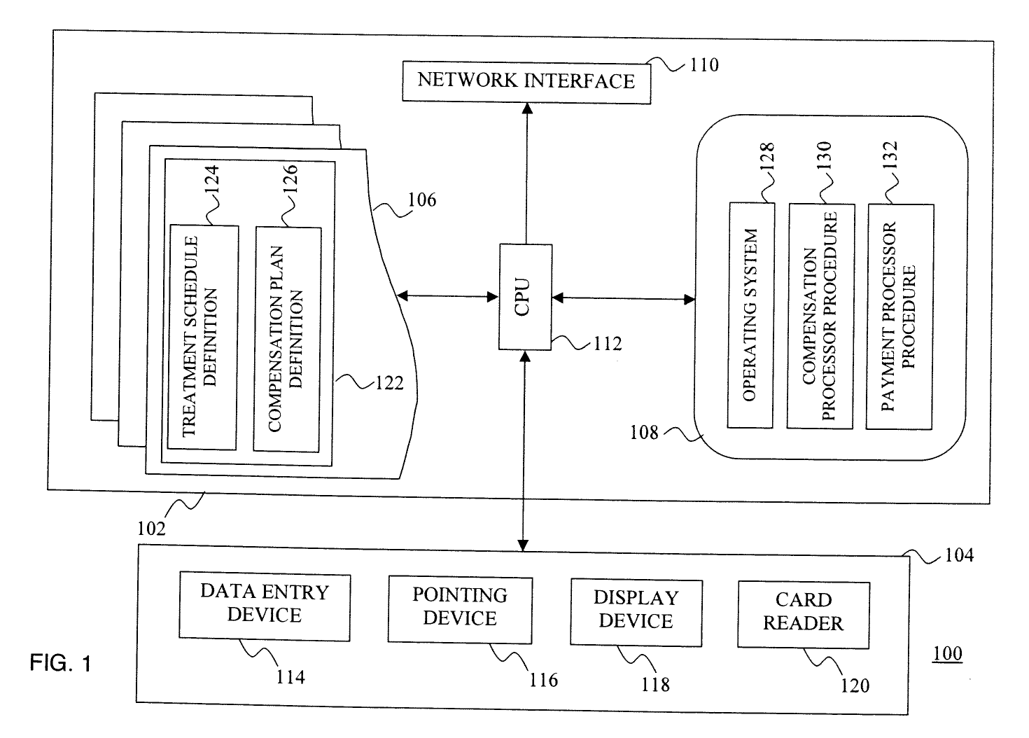

Turning to FIG. 1, there is provided a general-purpose computer, denoted generally with reference numeral 100, that comprises a data processing system 102, and an I/O sub-system 104 connected to the data processing system 102. The data processing system 102 comprises a non-volatile memory (ROM) 106, a volatile memory (RAM) 108, a network interface 110, and a microprocessor (CPU) 112 connected to the ROM 106, the RAM 108 and the network interface 110.

The I/O sub-system 104 comprises a data entry device 114, a pointing device 116, a display device 118, and a card reader 120. The data entry device 114 typically comprises a keyboard and/or a keypad. The pointing device 116 typically comprises a mouse or tablet. The display device 118 typically comprises a cathode ray tube (CRT) display or a liquid crystal display (LCD). The card reader 120 typically comprises a magnetic stripe card reader and/or a Smartcard reader. Further, the card reader 120 may be configured as a contact-type or contactless-type card reader.

The ROM 106 typically comprises a magnetic or optical disc memory, and includes therapeutic treatment membership database 122. The therapeutic treatment membership database 122 comprises one or more plurality of database records, each defining characteristics of a respective therapeutic treatment membership. Further, each database record includes a unique identifier that the computer 100 uses to identify the associated therapeutic treatment membership.

Each therapeutic treatment membership has an associated treatment schedule definition 124, and an associated compensation plan definition 126. The treatment schedule definition 124 specifies one or more parameters pertaining to the provision of therapeutic services to the purchaser of the therapeutic treatment membership. For instance, the treatment schedule definition 124 may specify the therapeutic services that are authorized to be provided to a purchaser of the therapeutic treatment membership. For instance, the treatment schedule parameters of the treatment schedule definition 124 may indicate that the authorized therapeutic services comprise exercise, massage, hydrotherapy, modalities (including, but not limited to water, light, heat, cold and electrical modalities), and/or any other therapy intended to restore the normal function or well-being of the recipient.

The treatment schedule parameters of the treatment schedule definition 124 may also specify an authorized frequency period (e.g. a maximum authorized total number of therapeutic treatments, and/or a maximum authorized frequency) for the provision of the therapeutic treatments to the purchaser of the therapeutic treatment membership. Preferably, the therapeutic treatment membership database 122 also maintains, for each therapeutic treatment membership, a total count of the number of treatments that have been provided to the purchaser of the therapeutic treatment membership over the authorized frequency period.

For instance, the treatment schedule definition 124 may specify a maximum daily, weekly or monthly treatment frequency, or a monthly or yearly maximum number of treatments which the recipient can receive the therapeutic treatments, in which case the therapeutic treatment membership database 122 would maintain for the associated therapeutic treatment membership a total count of the number of treatments that have been provided to the purchaser of the therapeutic treatment membership over the day, week, month or year, depending upon the treatment schedule definition 124.

The compensation plan definition 126 specifies one or more parameters regarding the manner in which compensation for the therapeutic services is provided to the purchaser of the therapeutic treatment membership. For instance, the compensation plan parameters of the compensation plan definition 126 may specify a monetary value for each one of the therapeutic treatments. The monetary value of a treatment is the monetary amount that is allocated by the therapeutic treatment membership to each therapeutic treatment, and may be equal to the amount that the recipient of the treatment would normally have to pay for the therapeutic treatment, absent the therapeutic treatment membership.

The compensation plan parameters of the compensation plan definition 126 may specify a maximum monetary payment amount for therapeutic treatments. The maximum monetary payment amount is the maximum amount that the purchaser of the therapeutic treatment membership will have to pay for the therapeutic services over the term of the therapeutic treatment membership. For instance, the therapeutic treatment membership may have a term of one year, in which case the maximum monetary payment amount would be the maximum amount that the purchaser of the therapeutic treatment membership would have to pay for the therapeutic services for the year.

As will be discussed below, the computer 100 issues receipts to the purchaser therapeutic treatment membership for the monetary value of the therapeutic treatments. The compensation plan parameters may specify a receipt issuance frequency for the issuance of the receipts. For instance, the compensation plan parameters may indicate that a receipt is to be issued after each therapeutic treatment, or after a plurality of therapeutic treatments have been rendered. Preferably, the compensation plan parameters prohibit issuance of a receipt until the amount paid by the purchaser for the therapeutic treatment membership at least equals the monetary value of the therapeutic treatments.

Preferably, the therapeutic treatment membership database 122 also maintains, for each therapeutic treatment membership, a total of the monetary value of all the therapeutic treatments that have been provided to the purchaser of the therapeutic treatment membership over the term of the therapeutic treatment membership.

The ROM 106 also comprise a plurality of computer processing instructions which, when loaded into the RAM 108 and executed by the CPU 112, comprise an operating system 128, a compensation processor procedure 130, and a payment procedure 132. The operating system 128 allows the data processing system 102 to communicate with the I/O sub-system 104, and to read/write records to/from the treatment membership database 122.

The compensation processor procedure 130 is configured to access the therapeutic treatment membership database 122. As will be described in greater detail, the compensation processor procedure 130 is configured to authorize a therapeutic treatment to be provided to a purchaser of a therapeutic treatment membership based on the treatment schedule definition 124, and to issue a receipt to the purchaser for the monetary value of the therapeutic treatment if the total monetary value of the therapeutic treatments (as defined by the compensation plan definition 126) provided to the purchaser during the term of the therapeutic treatment membership is less than the maximum monetary payment amount specified by the compensation plan definition 126. Although the compensation processor procedure 130 is typically implemented as computer processing instructions, the compensation processor procedure 130 may also be implemented in dedicated electronics hardware, such as an application specific integrated circuit (ASIC).

The general-purpose computer 100 is interfaced with a computer network, and the network interface 110 allows the general-purpose computer 100 to communicate with other devices/computers on the computer network. The payment procedure 132 interfaces with the card reader 120 and allows the recipient of the therapeutic treatments to pay for rendered treatments, via the computer network, using a debit card, a credit card and/or an electronic payment card.

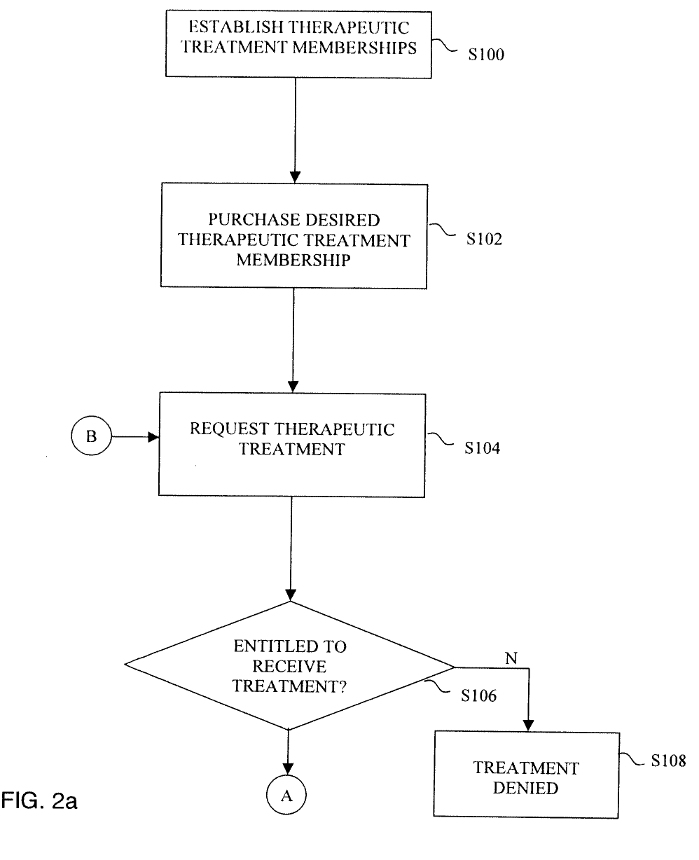

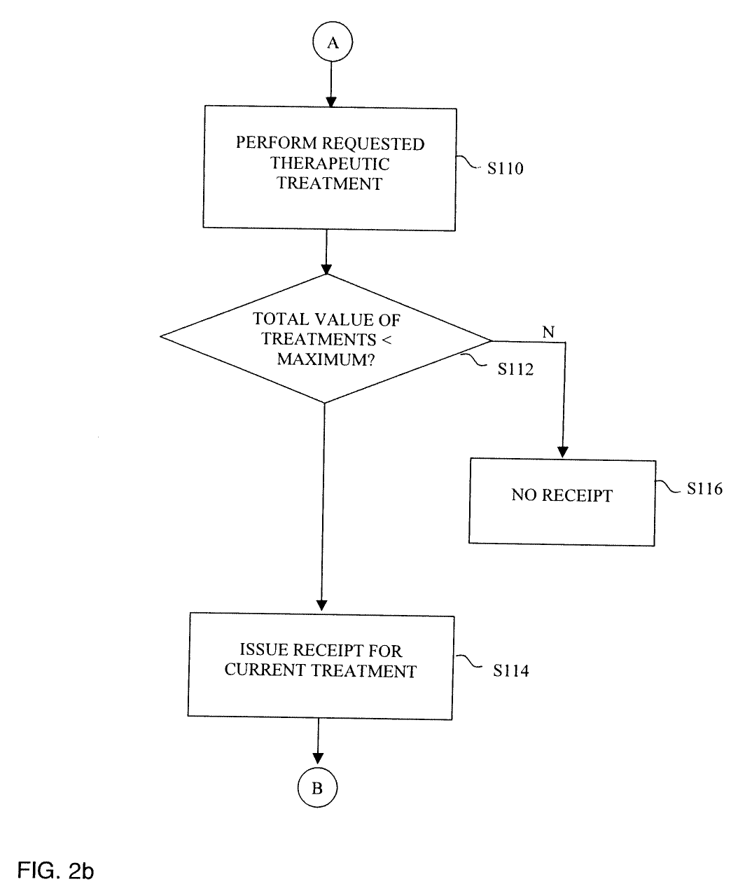

The method of operation of the compensation processor procedure 128 will now be described, in detail, with reference to FIGS. 2a and 2b.

At step S100, a therapeutic services facility establishes one or more therapeutic treatment memberships, the parameters of which are defined in the therapeutic treatment membership database 122. The therapeutic services facility may be any facility that provides one or more rehabilitative therapeutic services to its clientele for the treatment or management of a disability, illness, disease, disorder, injury, malfunction, dysfunction or pain without the use of pharmaceuticals, surgery or radiation.

An individual who considers it desirable to have one or more of the therapeutic treatments, selects one of the therapeutic treatment memberships based, for example, on the allowed therapeutic treatments, frequency and maximum payment amount parameters. The individual then purchases the desired therapeutic treatment membership, at step S102, either by providing an up-front lump sum payment, or several periodic payments.

Preferably, the therapeutic services facility issues to the purchaser a membership token (e.g. magnetic strip card or Smartcard) which encoded with the identifier that is uniquely associated with the therapeutic treatment membership in the therapeutic treatment membership database 122. The unique identifier may be magnetically or electronically encoded in, and/or visually encoded on the membership token.

Subsequently, when the purchaser of the therapeutic treatment membership is in need of a therapeutic treatment, the individual attends at the premises of the therapeutic services facility at step S104, and requests one of the therapeutic treatments.

Preferably, the individual presents the membership token to an admissions clerk to allow the admissions clerk to access the individual's therapeutic treatment membership particulars via the computer 100. Using the card reader 122, the admissions clerk reads the unique identifier that is encoded on the membership token. Alternately, the admissions clerk may manually input the unique identifier into the computer 100 using the data entry device 114 and the pointing device 116. The compensation processor procedure 130 then accesses the associated therapeutic treatment membership in the therapeutic treatment membership database 122.

At step S106, the compensation processor procedure 130 accesses the treatment schedule definition 124 to determine whether the individual is entitled to receive the requested therapeutic treatment at the therapeutic services facility. For instance, the individual's treatment schedule definition 124 might not allow the requested treatment. Alternately, the therapeutic treatment membership database 122 might reveal that the individual has exceeded the maximum allowed treatment frequency for the requested treatment. Alternately still, the individual might not have paid all periodic payments (if any) required by the individual's therapeutic treatment membership. In any of these situations, the compensation processor procedure 130 notifies the admissions clerk, by a suitable message on the display device 118, that the individual is not authorized to receive the requested therapeutic treatment, at step S108.

However, if the requested treatment is allowed by the individual's treatment schedule definition 124, the individual has not exceeded the maximum allowed treatment frequency for the requested treatment, and the individual's payments are current, the compensation processor procedure 130 notifies the admissions clerk, by a suitable message on the display device 118, that the individual is authorized to receive the requested therapeutic treatment. Qualified personnel at the therapeutic services facility then provide the individual with the requested therapeutic treatment, at step S110.

After the individual is provided with the requested therapeutic treatment, the admissions clerk uses the data entry device 114 and the pointing device 116 to update the individual's therapeutic treatment membership particulars in the therapeutic treatment membership database 122 to indicate that the requested therapeutic treatment has been provided to the individual.

At step S112, the compensation processor procedure 130 determines whether the total monetary value of the therapeutic treatments rendered to the individual to-date (including the current therapeutic treatment) during the term of the therapeutic treatment membership is less than or equal to the maximum monetary payment amount specified in the compensation plan definition 126 of the individual's therapeutic treatment membership.

If this condition is satisfied, at step S114 the compensation processor procedure 130 issues a receipt to the individual for the value of the therapeutic treatment, as specified in the compensation plan definition 126, in accordance with the receipt issuance frequency specified in the compensation plan definition 126. The receipt may be issued in hardcopy (paper) form via a printing device (not shown), and/or may be transmitted electronically to a destination address (eg. e-mail address, network address) specified by the compensation plan definition 126. Preferably, the receipt will be in a form suitable for use by the individual's health insurance provider to compensate the individual for the value of the therapeutic treatment. Alternately, the receipt may be in a form suitable for use by the individual as an income tax deduction.

However, if the monetary value of the therapeutic treatments rendered to the individual to-date is greater than the maximum monetary payment amount, at step S116 typically the compensation processor procedure 130 does not issue a receipt to the individual. Optionally, however, the individual may purchase additional therapeutic treatments, or may upgrade to a different therapeutic treatment membership that has a greater maximum monetary payment amount, in which case the compensation processor procedure 130 may issue receipts for the additional therapeutic treatments. Alternately, the individual may purchase additional therapeutic treatments, and receive for the additional payments a tax receipt that is issued strictly for income tax purposes.

An advantage of this compensation method, over conventional health insurance methods, is that the individual who is need of significant therapeutic services can continue to receive therapeutic treatments, free of charge, provided that the parameters (e.g. allowed therapeutic treatments, maximum allowed treatment frequency) of the therapeutic treatment membership are not violated.

Another distinct advantage of this method, over conventional health insurance methods, is that since the therapeutic services facility does not issue a receipt unless the total monetary value of the therapeutic treatments rendered to the individual to-date is less than the maximum monetary payment amount specified in the compensation plan of the individual's therapeutic treatment membership, the liability of the insurance provider is effectively capped at the maximum monetary payment amount.

Further, many individuals will typically under-utilize their therapeutic treatment membership, in the sense that they will not use all of the therapeutic treatments allowed by their therapeutic treatment membership. Therefore, another distinct advantage of this method, over conventional health insurance methods, is that the therapeutic services facility captures all payments that are made by the purchaser on the therapeutic treatment membership, whether or not the therapeutic treatments allowed by the therapeutic treatment membership are actually rendered. As a result, the therapeutic services facility is able to subsidize the costs of therapeutic treatments that are provided to individuals who are in most need of these treatments from the membership purchase price paid by the individuals who under-utilize their therapeutic treatment membership.

Although, in the above example, the general-purpose computer 100 is implemented as a form of stand-alone computer and is deployed at the therapeutic services facility, the general-purpose computer 100 may be implemented as a computer server that is deployed at a secure location remote from each therapeutic services facility. In this variation, the computer server may be configured to communicate over the computer network with networked clients that are deployed at respective therapeutic services facilities, and may authorize the rendering of therapeutic treatments and the issuance of the receipts to the network clients via the computer network.

I claim:

1. A method of providing compensation for therapeutic treatments, comprising the steps of:
defining at least one therapeutic services membership having an associated compensation plan and a treatment plan, the compensation plan establishing a maximum monetary payment amount for therapeutic treatments and a monetary value for each one of the therapeutic treatments, the treatment plan establishing at least one of a maximum authorized total number of the therapeutic treatments and a maximum authorized frequency of performance of the therapeutic treatments;
at an input device receiving an indication of one of the therapeutic services memberships;
authorizing the rendering of one of the therapeutic treatments to a recipient of the one therapeutic services membership in accordance with the treatment plan; and
issuing a receipt to the recipient for the monetary value of the rendered therapeutic treatment only if a total of the monetary values of the rendered therapeutic treatments is less than the maximum monetary payment amount.

2. The method according to claim 1, wherein the receipt comprises one of a tax receipt and a receipt for receiving reimbursement from an insurance plan.

3. The method according to claim 2, wherein the therapeutic services membership has an associated purchase price, the purchase price not exceeding the maximum monetary payment amount.

4. A therapeutic treatment compensator comprising:
a database defining at least one therapeutic services membership, each said therapeutic services membership having an associated compensation plan definition and treatment plan definition, the compensation plan definition comprising a maximum monetary payment amount for therapeutic treatments and a monetary value for each one of the therapeutic treatments, the treatment plan definition comprising at least one of a maximum authorized total number of the therapeutic treatments and a maximum authorized frequency of performance of the therapeutic treatments; and
a compensation processor configured for communication with the database, the compensation processor being further configured to authorize the rendering of one of the therapeutic treatments to a recipient of the therapeutic services membership in accordance with the treatment plan definition, and to issue a receipt to the recipient for the monetary value of the rendered therapeutic treatment only if a total of the monetary values of the rendered therapeutic treatments is less than the maximum monetary payment amount.

5. The therapeutic treatment compensator according to claim 4, wherein the receipt comprises one of a tax receipt and a receipt for receiving reimbursement from an insurance plan.

6. A method of providing compensation for therapeutic treatments, comprising the steps of:
establishing a therapeutic services membership having an associated compensation plan, the compensation plan establishing a maximum monetary payment amount for therapeutic treatments;
rendering the therapeutic treatments to a recipient of the therapeutic services membership, the rendered therapeutic treatments having an associated monetary value; and
effecting compensation to the recipient in accordance with the compensation plan, the compensation providing the therapeutic treatments to the recipient without monetary payment upon the total monetary value of the rendered therapeutic treatments exceeding the maximum monetary payment amount.

7. The method according to claim 6, wherein the step of effecting compensation comprises providing to the recipient proof of performance of the rendered therapeutic treatments in accordance with the associated monetary value, the monetary value of the proof of performance not exceeding the maximum monetary payment amount.

8. The method according to claim 7, wherein the proof of performance comprises one of a tax receipt and a receipt for receiving reimbursement from an insurance plan.

9. The method according to claim 8, wherein the therapeutic services membership has an associated purchase price, the purchase price not exceeding the maximum monetary payment amount.

10. The method according to claim 8, wherein the therapeutic services membership has an associated maximum frequency of performance of the therapeutic treatments.
